(19) United States
(12) Patent Application Publication
(10) Pub. No.: US 2026/0054641 A1
(43) Pub. Date: Feb. 26, 2026

(54) GLAZING HAVING A LIGHT INJECTION ASSEMBLY

(71) Applicant: AGP WORLDWIDE OPERATIONS GMBH, Zug (CH)

(72) Inventors: Alexey KRASNOV, Canton, MI (US); Andrés Fernando SARMIENTO SANTOS; Araz DARBA, Gent (BE); Cristian AMAYA, Cercado de Lima (PE); Daniel ESTRADA DIAGO, Lima (PE); Deborah GONZALES VILLACORTA, Cercado de Lima (PE); Diego Andrés REYES CAVIEDES, Cercado de Lima (PE); Gonzalo R. VIZCARRA MENDOZA, Canton, MI (US); Ian J. RIOFRIO, Lima (PE); José Manuel CAMPOS MENESES, Cercado de Lima (PE); Juan CASTRO, Lima (PE); Juan MELGAR RONDON, Cercado de Lima (PE); Mauricio SALAZAR ASTETE, Lima (PE); Melany Koral SOTO CARRION, Lima (PE); Natalia Andrea RUEDA GUERRERO, Lima (PE); Stefan GOSSEN, Aachen (DE)

(21) Appl. No.: 19/103,288

(22) PCT Filed: Aug. 4, 2023
(86) PCT No.: PCT/IB2023/057922

§ 371 Date: Feb. 12, 2025

Related U.S. Application Data
(60) Provisional application No. 63/371,340, filed on Aug. 12, 2022.
(60) Provisional application No. 63/492,463, filed on Mar. 27, 2023.

(51) Int. Cl. B60Q 3/208; B60J 1/00; F21V 8/00

(52) U.S. Cl. CPC B60Q 3/208; B60J 1/001; G02B 6/0023

(57) ABSTRACT

In automotive lighting applications, ambient lighting has been very popular recently wherein the glazing serves to conduct and deliver light to the cabin in much the same way that a fiber optic does. More specifically, illumination is provided by injecting light into the glass where the light is trapped within the glass by total internal reflection. The present invention relates to a high efficiency light injection assembly comprising a light coupling element having a cavity and a lighting means. The light injection assembly of this invention allows for design flexibility as well as a significant height reduction keeping a proper light injection efficiency in order to guarantee a proper ingress protection grade and automotive requirements compliance.

### FIELD OF THE INVENTION

The invention relates to the field of laminated automotive glazing, in particular in the field of automotive interior lighting.

### BACKGROUND OF THE INVENTION

The transportation industry is now adapting to offer to the market more sustainable means of transportation such as low-emission and electric vehicles. The preference for large glazing roofs and windshields is coming to the cost of having to embed technology such as lighting, displays and other controls into the glazing.

A challenge when designing vehicles with large glass roofs is cabin lighting. It is often not possible, practical, or desirable to mount a light on the glass of the roof due to the need to route the wiring harness supplying power to the light across the glazing, to add a cover to hide the harness from the interior of the vehicle, and to add a black print to hide the harness from the exterior. However, efforts to embed light-emitting diodes (LEDs) in laminated glass have met with mixed results. One of the key issues is the high intensity of LEDs intended for general illumination. For one, it is difficult to connect the LEDs in a manner where the wires are not readily visible. Various approaches have been used including, very thin wires embedded in the plastic bonding layer, the use of a transparent conductive coating on the glass, and a transparent plastic substrate with a transparent conductive coating. All can be used but add complexity and cost. Also, due to the small size of the LED die and the difficulty in including any kind of a lens or diffuser in a laminate, the light intensity (lumens per unit area) of the LED die tends to be very high. This bright point source can make night driving difficult for the driver. Another issue is heat. While LEDs are much more energy efficient than incandescent lamps, producing far less waste heat, they still generate some heat which must be managed. As glass and the plastic bonding layer are both good thermal insulators, overheating can occur if the LEDs are placed too close together. In addition, the index of refraction of common plastic bonding layers such as PVB, is temperature dependent so any temperature gradient arising from the LEDs can result in undesirable optical distortion.

An alternative method of illumination uses the glass layers of the laminate as a light conducting layer, to direct light to the cabin interior.

One of the most aesthetic appealing solutions for interior lighting is to have a lighting source attached to the edge of the glazing and emitting such as the light is guided inside the glazing through total internal reflection and scattered at specific features, also called scattering means, on the surface illuminating the passenger cabin. The glazing itself is used to conduct light in a manner similar to that of an optical fiber.

To date, light injection has primarily been accomplished by optically coupling the light into the glass from at least one edge of the glazing. This method has been known and in use for many years in non-automotive applications.

In the same manner, edge injection of light into the vehicle glazing can be used to provide ambient cabin illumination. The glass functions as a light conducting layer for the light. The light is decoupled and refracted by a light scattering means on the glass surface. Light dispersing surface treatments and materials are known that when applied to glass are substantially invisible/transparent when the lighting means is in the off state while providing illumination in the on state. The light dispersing may be patterned to form a graphic.

A typical configuration comprises a laminated glazing with two glass layers wherein at least a portion of the periphery of a first glass layer is offset inboard from the second glass layer. In the area of the first glass layer that does not overlap the offset second glass layer, a light source such as a light bar is positioned. The light bar directs light into the edge of the smaller second glass layer which serves as a light conducting layer.

This approach is advantageous as the electrical connections for the light source do not need to be exposed in the center of the glazing. However, a major drawback is the illumination intensity that is very poor and therefore larger power and more lighting bulbs are needed.

Another drawback, is the mechanical resistance of the laminated glazing, jeopardized by the inboard offset of the second glass layer.

Most of the times, the car manufacturers opt for using point light sources that emit in all directions and only a portion of the light that emits in a range of angles actually enters and propagates throughout the length of the glazing. Therefore, more light sources, or a light source with higher illumination intensity needs to be used and it requires more power and consequently releases more heat.

It would be desirable to have an illuminated laminate without the drawbacks of the prior art.

### BRIEF SUMMARY OF THE INVENTION

The present invention provides a solution for the above mentioned issues by an illuminated glazing for a vehicle according to claim 1 and an automotive roof according to claim 27. In dependent claims, preferred embodiments of the invention are defined.

A first inventive aspect of the invention provides an illuminated glazing for a vehicle, the glazing comprising:
at least one glass layer, having a major surface three, and a major surface four, and serving as a light conducting layer;
a light injection assembly comprising:
   a light coupling element having a cavity; and
   a lighting means having an emitting face, positioned inside said cavity and
   connected to the light coupling element, and/or to the at least one glass layer;
wherein the light coupling element is geometrically shaped and configured to provide optimal light injection angles into the at least one glass layer;
wherein the light coupling element is configured to allow Total Internal Reflection (TIR) within said light coupling element to at least a portion of the light emitted by the lighting means; and
wherein the light coupling element is attached to a major surface of the at least one glass layer.

The light coupling element is configured to provide optimal light injection angles for the light rays travelling from the lighting means and entering into the at least one glass layer. The optimal angles range should be below the critical angle calculated by the light travelling from the coupling element having an index of refraction n2, to the at least one glass layer, having an index of refraction n3, such that the absolute value of the difference between n2 and n3 is at most 0.15, preferably at most 0.1 and more preferably at most 0.05.

Advantageously, the geometric shape of the light coupling element is such that allows for TIR within the light coupling element, specifically recollecting and redirecting at least a portion of the light emitted by the lighting means, i.e., the light rays scattered by the lighting means and from internal losses. The light coupling element is a core element having an external perimetral surface shape portion. Moreover, the perimetral surface of the light coupling element may have variable radius of curvature from 4 to 100 mm, preferably from 5 to 60 mm.

The lighting means is positioned inside of the light coupling element cavity and is connected such as attached, fixed or making physical contact to the light coupling element, and/or to the at least one glass layer. The emitting face of the lighting means may be positioned at an angle with respect to the normal of the glazing surface below the critical angle to allow for light injection into the at least one glass layer. Additionally, the light coupling element could comprise a housing or could be encapsulated for protecting against humidity and external agents.

A second inventive aspect of the invention provides a vehicle roof comprising the illuminated automotive glazing of the first inventive aspect.

A third aspect of the invention, not claimed, provides an illuminated automotive glazing comprising a disposition of multiple light coupling elements with a section bar type that are arranged facing the obscuration and close to the inner edge of the obscuration and wherein the distance between the coupling element and the inner edge of the obscuration is preferably less than 400 mm, more preferably less than 200 mm and even more preferably less than 80 mm.

A fourth aspect of the invention, not claimed, is provided by an illuminated glazing comprising a light coupling element bar type that is attached to a portion of a major surface of a curved glass layer by an adhesive, wherein the curvature of the light coupling element in its longitudinal section is substantially the same than the curvature of the portion of the major surface of the glass layer where the light coupling element is disposed, and wherein the coupling element can be rigid or flexible.

### Advantages

Higher light injection efficiency than conventional edge injection
Precise control of injection angle
No change to the size of the glazing is required
Easier to package
Easier to manage heat
Improves mechanical behavior of the laminated glazing

### BRIEF DESCRIPTION OF THE SEVERAL VIEWS OF THE DRAWINGS

FIGS. 1A to 1G are cross sections (not to scale) of embodiments of the invention of an illuminated glazing having a light injection assembly.

FIGS. 2A and 2B are cross sections (not to scale) of embodiments of the invention of an illuminated laminated glazing having a light injection assembly.

FIG. 3 is an isometric view of a roof showing (not to scale) with different locations of the light coupling element bar type.

FIGS. 4A and 4B show the cross-section (not to scale) A-A and B-B of one embodiment of the invention.

FIGS. 5A and 5B show the cross-section (not to scale) B-B of another embodiment of the invention.

FIGS. 6A and 6B show the cross-section (not to scale) B-B of another embodiment of the invention.

FIGS. 7A and 7B show the cross-section (not to scale) of embodiments of the invention of an illuminated laminated glazing having a light injection assembly.

FIG. 8 is an isometric view of one embodiment of the light coupling element.

FIGS. 9A, 9B and 9C show a plant view (not to scale) of embodiments of the invention of an illuminated laminated glazing having a light injection assembly.

FIGS. 10A and 10B show a schematic view (not to scale) of the electrical interconnections of one embodiment of the invention of an illuminated laminated glazing having a light injection assembly.

FIGS. 10C and 10D show a schematic view (not to scale) of the electronic interaction among light injection assemblies of one embodiment of the invention of an illuminated laminated glazing.

### REFERENCE NUMERALS OF DRAWINGS

4 Bonding plastic layer
6 Obscuration/Black Paint
7 light boosting means
8 Inner edge of the obscuration
20 Light injection assembly/Light structure assembly
21 LED
22 Light emitting means/lighting means
23 Reflector/reflective element/reflective coating
24 Lens
25 Emitting face of the lighting means/lighting means emitting face
26 Light source
27 Smart LED
28 light coupling element
29 Slot
30 Housing or encapsulation
32 Printed circuit board (PCB)/Additional substrate
34 Flexible printed circuit (FPC)/Substrate
35 Electrical connections
36 Cavity
37 Air gap
40 Adhesive
50 Light Module
60 Light scattering means
70 Driver
71 Master
72 Slave
73 ECU
101 Surface one, number one major surface
102 Surface two, number two major surface
103 Surface three, number three major surface
104 Surface four, number four major surface
200 Glazing
201 Exterior glass layer/Outer glass layer
202 Glass layer/Interior glass layer/Inner glass layer/light conducting layer
281 Light coupling element piece one
282 Light coupling element piece two
283 Light coupling element piece three

### DETAILED DESCRIPTION OF THE INVENTION

The present disclosure can be understood by reference to the detailed descriptions, drawings, examples, and claims in this disclosure. However, it is to be understood that this invention is not limited to the specific compositions, articles, devices, and methods disclosed unless otherwise specified and as such can, of course, vary. The following terminology is used to describe the laminated glazing of the invention. It is also to be understood that the terminology used herein is for the purpose of describing aspects only and is not intended to be limiting.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

The structure of the invention is described in terms of the layers comprising the glazing. The meaning of “layer,” as used in this context, shall include the common definition of the word: a sheet, quantity, or thickness, of material, typically of some homogeneous substance and one of several.

Laminates, in general, are articles comprised of multiple layers of thin, relative to their length and width, material, with each thin layer having two oppositely disposed major surfaces, typically of uniform thickness, which are permanently bonded to one and other across at least one major surface of each layer. The layers of a laminate may alternately be described as sheets or plies. In addition, the glass layers may also be referred to as panes.

Laminated safety glass is typically made by bonding two layers of annealed glass together using at least one plastic bonding layer comprised of at least one thin sheet of transparent thermoplastic layer, also known as plastic bonding layer, plastic layer, adhesive interlayer or interlayer.

A typical automotive laminate glazing is comprised of two layers of glass, the first, exterior or outer, (201) and second, interior or inner, (202) that are permanently bonded together by a plastic bonding layer (4). In a laminate, the glass surface that is on the exterior of the vehicle is referred to as surface one, (101), or the number one major surface. The opposite face of the exterior glass layer (201) is surface two, (102), or the number two major surface. The glass surface that is on the interior of the vehicle is referred to as surface four, (104), or the number four major surface. The opposite face of the interior layer of glass (202) is surface three, (103), or the number three major surface. Major surfaces two, (102), and three, (103), are bonded together by the plastic bonding layer (4). In the context of this invention, the sides of the automotive laminate glazing and/or the glass layers and/or the major surface of the glass layers should be understood as the lateral and frontal/back edges of the glazing when it is installed in a vehicle.

In an automotive laminate glazing at least a portion of the periphery of the outer glass layer (201) can be offset inboard from the inner glass layer (202), or the periphery of the outer glass layer (201) can match with the periphery of the inner glass layer (202). In automotive laminated glazing at least of a portion of maximum 5 mm of the periphery of the outer glass layer (201) can be offset inboard from the inner glass layer (202), preferably of maximum 3 mm, more preferably maximum 2 mm and even more preferably maximum 1 mm.

An obscuration (6) may be also applied to the glass. Obscurations are commonly comprised of black enamel frit printed on either the number two, (102), or number four surface (104), or on both. Obscurations can also be provided with painted or opaque plastic layers, as well as by the use of organic paint. The laminate may have a coating on one or more of the surfaces.

The laminate may also comprise at least a film laminated between at least two plastic bonding layers (4).

The plastic bonding layer (4) has the primary function of bonding the major surfaces of adjacent layers to each other. The material selected is typically a clear thermoset plastic. For automotive use, the most used bonding layer (4) is polyvinyl butyral (PVB), however other bonding layers such as ethylene vinyl acetate (EVA) and thermoplastic polyurethane (TPU), polyolefin elastomers (PoE), polyethylene terephthalate (PET), optical adhesive resins (OCR), liquid optically clear adhesives (LOCA) or any combination thereof may be used may be also widely used. Preferably, the thickness of the plastic bonding layer is comprised between 0.1 mm and 2.0 mm, preferably between 0.5 mm and 1.0 mm, particularly 0.38 mm, 0.631 mm, and 0.76 mm. Colored plastic boding layers such as colored PVBs can also be used, for instance, dark grey PVBs varying the total visible light transmission of the laminate to less than 100%.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass.

Preferably, the thickness of the outer (201) and inner (202) glass layer may vary widely and thus be ideally adapted to the requirements of the individual cases. In an embodiment, the thickness of each glass layer of the glazing of the invention ranges from between 0.5 mm to 4 mm. In another embodiment, the outer (201) and inner (202) glass layer can be of different tinted colors, i.e., a dark solar green soda lime, among other combinations.

Clear glass is considered as one that has a VLT of at least 86%. There is also what is known as an ultra-clear glass which has a VLT of at least 89%. In one preferred embodiment the outer glass layer (201) has a total visible light transmission of at least 86%, preferably of at least 89%. In another preferred embodiment the inner glass layer (202) has a total visible light transmission of at least 86%, preferably of at least 89%.

In yet another embodiment, the glass layers of the glazing may be press bent to shape or gravity bent, when bent glass layers are laminated, cold-bending of the inner glass layer (202) may also be possible

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic bonding layer helping to maintain the structural integrity of the glass. A vehicle with a broken windshield can still be operated. The plastic bonding layer also helps to prevent penetration by objects striking the laminate from the exterior and in the event of a crash occupant retention is improved.

Laminated safety glass may also comprise strengthened glass such as semi-tempered, fully-tempered or chemically strengthened glass layers. In this sense the glass undergoes a heat treatment in the first cases, or an ion exchange chemical process well known in the industry such as to generate compressive stress onto the surface of the glass.

When multiple layers that vary widely in thickness are illustrated, it is not always possible to show the layer thicknesses to scale without losing clarity. Unless otherwise stated in the description, all figures are to be considered as for illustrative purposes and are not drawn to scale and thus shall not be construed as a limitation.

The invention is based up the principle of Total Internal Reflection (TIR), which will be briefly explained.

The index of refraction (IOR), of a material is defined as the ratio of the velocity of light (c) in vacuum to the velocity (v) of light in the material/medium.

$$I O R = c / v$$

The IOR of a material is typically equal to or greater than one. The more optically dense a material is, the slower light will move through the material.

Refraction occurs when the path of a light beam changes as it travels from one medium to another with a different refractive index. Refraction is caused by the change in the speed of light in the media. The light beam will bend at the interface of the two media/materials. If the light slows down, it will diverge away from the surface normal. If the light speeds up, it will diverge towards the surface normal.

The change in direction is a function of the ratio of the refractive index of the second medium to the first.

When light travels from a medium with a higher refractive index to one with a lower refractive index, the light will refract and exit the denser (higher IOR) medium if the angle of the beam relative to the surface normal is less than the critical angle. If the angle of incidence is equal to or greater than the critical angle, TIR occurs.

The critical angle is the smallest angle of incidence of light travelling in one medium and reaching the interface of an adjacent medium that is optically different (has a different index of refraction) where light suffers total internal reflection. The medium where the light suffers total internal reflection is called light conducting layer. Any light incident to the interface at a smaller angle than the critical angle will refract to the adjacent medium.

If nₓ is the refractive index of the glazing and n_{y} is the refractive index of the adjacent medium in direct contact with it such as in surface one, (101), or surface four, (104), then the critical angle θ_{c} is calculated by:

$${θ}_{c} = arcsin \frac{{n}_{y}}{{n}_{x}}$$

Using refractive index values of 1 for air, 1.53 for typical soda lime glass we get critical angles of:

$${θ}_{glass / air} = 40.81 °$$

It should be noted that the example indices and critical angles given may vary depending on the media the light is travelling from and to.

Typically, conventional soda lime glass has an index of refraction in the range of 1.51 to 1.53.

Conventional PVB plastic bonding layer has an index of refraction of 1.47 to 1.49.

It can be seen that the critical angle at which TIR occurs may vary over a wide range depending upon the surface condition (interface between media) and the light injection angle.

In order to couple the light coming from a light source into the light conducting layer, a coupling element is provided. The coupling element captures and guide the light for the injection into the light conducting layer.

When TIR occurs, any substance present on the surface will frustrate TIR, allowing the light to exit the light conducting layer. Light decoupling means, also known as light scattering means, functions the same way. They frustrate TIR making light to exit the light conducting layer. This is the principle that the invention is based upon for providing interior illumination.

A light scattering means (60) is any means that will frustrate TIR in a light conducting layer allowing light to escape from the light conducting layer (202). This is accomplished by changing the angle of refraction to less than the critical angle or the index of refraction at the glass/air interface such that TIR no longer is possible. In one embodiment, the light scattering means (60) is applied to a major surface of any of the inner or outer layers, particularly to the light conducting layer by a variety of methods including but not limited to a graphic printed on the glass, sandblasting, chemically etching, LASER etching; scattering particles embedded on or in an inorganic or organic matrix, glass edging, sanding, organic or inorganic enamels and plastic bonding layers with scattering particles. The light scattering means (60) is applied such that a graphic design appears when light is injected. In another embodiment, the light scattering means (60) may also be applied or deposited onto the plastic bonding layer or in any other the plastic layer of the glazing optically compatible with the TIR. Light scattering means (60) may be comprised of a transparent ink, light dispersing particles or etching/ablation markings on the surface of the glass layer.

We shall use the word inject to describe the process of introducing light into the glass layer wherein the glass layer acts as a light conducting layer for the light, this is performed by a light injection assembly (20). In the context of this invention, the light injection assembly (20) comprises a geometrically shaped light coupling element (28) having a cavity (36), and a lighting means (22) having an emitting face (25) and positioned inside said cavity (36). The light injection assembly (20) may be integrated and combined as a part of a molding, frame, housing, bracket, encapsulation, or trim. The lighting means (22) directs the light at a specific angle or range of angles.

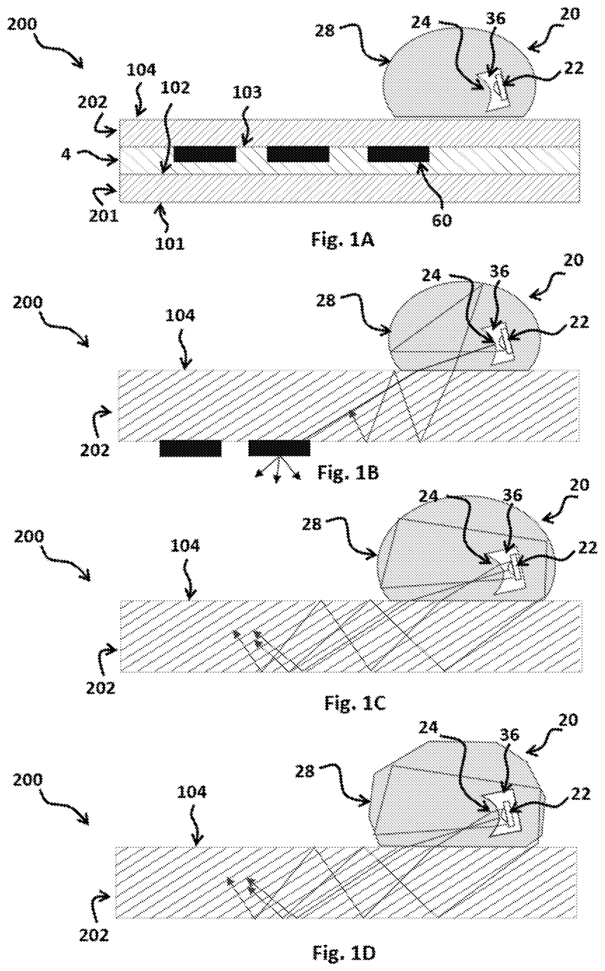

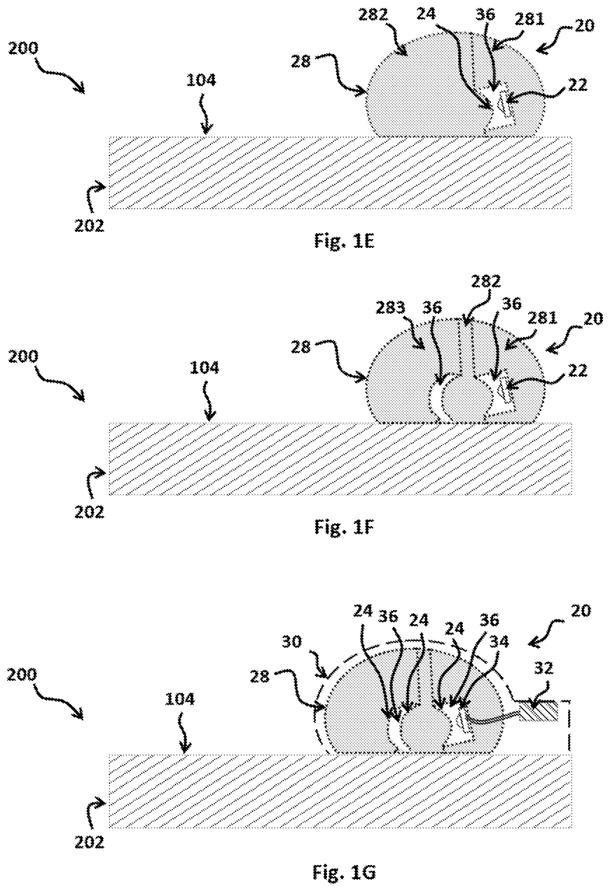

The light coupling element (28) has a core element having at least a portion of its cross-section having an external perimetral surface with variable radius of curvature. The external perimetral surface shape portion (geometrically shaped) may be selected from the group comprising elliptical-like, oval-like, convex and concave shape, cylindrical, toroidal/spherical, parabolic, conical shape, or the combination thereof. The geometrical shape of the light coupling element (28) is advantageously designed to increase the efficiency of the light that is injected into the glazing with respect to the light emitted by the lighting means (22). In particular, the radius of curvature of each region of the perimetral surface may have a range from 4 to 100 mm, preferably from 5 to 60 mm. Alternatively, or in combination, FIG. 1D illustrates that, in the crosswise direction, the geometrical shape of the light coupling element (28) could be a polyhedron with number and length of sides approximating an elliptical or oval shape with regions with variable radius of curvature in the range proposed formerly.

In a lengthwise section, the light coupling element (28) is formed as bar or a strip (bar type) of any desired length having the previously defined cross section containing one or multiple cavities (36) in which one or multiple lighting means (22) is/are disposed. The lengthwise section of the coupling element (28) can be straight or can be bent/curved, so the coupling element (28) can be adapted to the curvature of the glazing. Smaller sections and/or flexible materials may be preferred in the case of high curvature glazing. The length of the light coupling element (28) can be defined as desired such as to adapt to the curvature of the glazing and the lighting requirements. The length of the light coupling element can cover the whole length of the side of the glazing, or it can have a smaller length. A plurality of light coupling elements (28) preferably oriented in the longitudinal direction can be used to cover the length. In a preferred embodiment the light coupling element (28) has a length from 50 mm to 2500 mm. more preferably from 50 mm to 300 mm. The maximum length of 2500 mm may be achieved by using multiple light coupling elements (28).

A list of materials that could be suitable for the light coupling element (28) are but not limited to engineering plastics, transparent polyurethane (PU), polycarbonate (PC), polymethyl methacrylate (PMMA), LSR, silicone, polyamide (PA), thermoplastic polyurethane (TPU), cyclic olefin Polymer (COP), cyclic olefin copolymer (COC), quartz, glass transparent alumina and others. In one embodiment the light coupling element (28) is made of one material of the above or alternatively may be made of more than one material of the above, having different properties such as different refraction index, hardness, among others.

The light coupling element (28) is configured to provide optimal light injection angles for the light rays travelling from the lighting means (22) and entering into the at least one glass layer (202). The optimal angles range should be below the critical angle calculated by the light travelling from the coupling element (28) having an index of refraction n₂, to the at least one glass layer (202), having an index of refraction n₃, such that the absolute value of the difference between n₂ and n₃ is at most 0.15, preferably at most 0.1 and more preferably at most 0.05. In an embodiment, the light coupling element (28) has a refractive index preferably between 1.40 and 1.65, more preferably between 1.48 and 1.59, even more preferably from 1.51 to 1.56. In a preferred embodiment, the light coupling element (28) has a refractive index equal or higher than the refractive index of the glass layer (202) where is attached.

In an embodiment, the light coupling element (28) may be comprised of a rigid material. In an embodiment, the material has a hardness equal to or below 100 Shore D, preferably has a hardness from 50 to 100 Shore A or 50 to 100 shore D. The inventors have found that this feature allows for suitable flexibility and ease on installing onto the curved major surface of the glazing. Yet in another embodiment the light coupling element (28) may be comprised of a flexible material.

In this sense a light coupling element that comprises a rigid material is equivalent to a rigid light coupling element and shall be understood throughout this enclosure as a light coupling element which does not require the cooperation of a frame member, an adhesive and/or any other device to maintain its shape at the normal utilization temperatures A light coupling element that comprises a flexible material is equivalent to a flexible light coupling element and shall be understood throughout this enclosure as a light coupling element (28) which requires the cooperation of a frame member, an adhesive and/or any other device to maintain its shape at the normal utilization temperatures.

The light coupling element (28) could be comprised of one unique part, and this part has one cavity (36) for housing the lighting means (22). Alternatively, the light coupling element (28) may comprise more than one cavity (36) and one or multiple lighting means (22) could be housed into one or more cavities 36. Optionally, the light coupling element (28) could be comprised of more than one part or piece, such as two (281), (282) or three (281), (282), (283) or four independent parts or pieces that are joined or attached or assembled together.

The light coupling element (28) may be equipped with ribs, bosses, or other features to give it mechanical integrity and help hold it in place. The light coupling element (28) may be disposed on, attached, bonded, adhered, fixed and/or maintained in position to the major surface (104) of the glass layer (202) by different ways. In a first embodiment, the light coupling element (28) is directly attached to the major surface (104) of the at least one glass layer (202). In a second embodiment, the light coupling element (28) may be adhered to the major surface (104) of the glass layer (202) by a low tack adhesive that can subsequently be easily removed. In a third embodiment, the light coupling element (28) is attached, fixed and/or maintained in its position on the major surface (104) of the glass layer (202) by an adhesive (40).

The light coupling element (28) may also comprise protection means against humidity and/or external agents by having a housing and/or being encapsulated (30) shown in FIG. 1G. The housing and/or encapsulation (30) may be in direct contact with the light coupling element (28).

In a fourth embodiment, the housing or encapsulation (30) may also serve as a securing means to fix the light coupling element to the glazing surface without or with the combination of other fixing means such as an adhesive.

The coupling element (28) can be disposed on any area of the automotive glazing.

In an embodiment, there is at least one light coupling element (28) that is attached to and along the major surface (104) of the at least one glass layer (202) close to one or more edges of the glass layer (202). When multiple light coupling elements (28) are included, they can be located in opposite sides of the glass layer (202), in adjacent sides, in three sides, in four sides and along the perimeter of the glass layer (202).

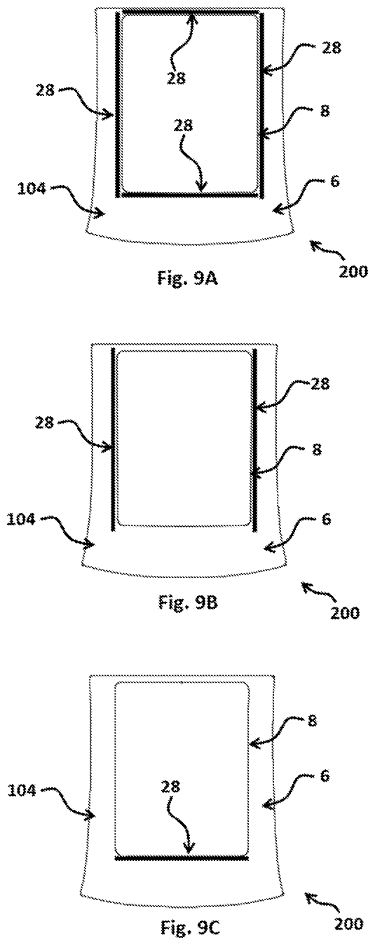

Alternatively, or additionally, in another embodiment there is at least one coupling element (28) that is attached to an along the major surface (104) of the at least one glass layer (202) and it is disposed facing the obscuration (6). When multiple light coupling elements (28) are included, they can be located in opposite sides of the glass layer (202), in adjacent sides, in three sides, in four sides and along the perimeter of the glass layer (202). In a particular embodiment of this embodiment, the coupling element (28) is arranged close to the inner edge of the obscuration (8). The inner edge of the obscuration (8) is the limit between the transparent area of the glazing (200) and the obscuration (6). This disposition allows a higher efficiency in the injection by minimizing the propagation distance of the light from the lighting means (22). The distance between the coupling element (28) and the inner edge of the obscuration (8) is preferably less than 400 mm, more preferably less than 200 mm and even more preferably less than 80 mm. This disposition is illustrated in FIG. 9A, FIG. 9B and FIG. 9C.

A third aspect of the invention, not claimed, is provided by an illuminated automotive glazing comprising a disposition of multiple light coupling elements with a section bar type that are arranged facing the obscuration close to the inner edge of the obscuration and wherein the distance between the coupling element and the inner edge of the obscuration is preferably less than 400 mm, more preferably less than 200 mm and even more preferably less than 80 mm. All embodiments disclosed in this invention are applicable to this third aspect of the invention. Likewise, this third aspect of the invention is not restricted to the light injection assembly (20) disclosed in claim 1.

The term light coupling element may be interchangeably used with coupling element, coupling means, optical filler and core.

The lightning means (22) is any means that at a minimum is capable of producing the intensity of illumination required, in the desired frequency band, and that can be successfully packaged.

The lighting means (22) comprises a light source (26) having an emitting face (25) and other associated components needed to inject the light into the light conducting layer (202). In one embodiment, the light source (26) is a plurality of LEDs (21), preferably an array of LEDs (21) and is sometimes called a light bar or light strip. In a particular embodiment, the LEDs (21) can be Smart LEDs (27). The LEDs (21) are packed in an assembly which is mounted such that the light is injected into the light conducting layer (202). In one embodiment, the other associated components comprise a substrate (34), such as a flexible printed circuit (FPC) (34), where the plurality of LEDs (21) is arranged. The substrate (34) can be manufactured of rigid or flexible materials, such as polyamide and/or FR4.

The lighting means (22) may be inserted into or located in the interior of the light coupling element (28). For that, a cavity (36) in the light coupling element (28) is provided. The lighting means (22) is positioned inside of the light coupling element cavity (36) and is connected such as attached, fixed or making physical contact to the light coupling element (28), alternatively, the lighting means (22) may be connected, such as disposed, onto the at least one glass layer (202). The cavity (36) may allow for the lighting means (22) to be inserted into/located in the interior of the light coupling element (28) such that it may be surrounded by the light coupling element material, and/or another additional coupling agent, and/or an “air gap”. An air gap (37) may separate the emitting face (25) of the lighting means (22) from the light coupling element (28). Advantageously, a lens (24) may be formed by the interface surface between the cavity “air gap” (36) and the light coupling element (28).

According to a first aspect of the invention, an illuminated automotive glazing (200) is provided which comprises:
at least one glass layer (202), having a major surface three (103), and a major surface four (104), and serving as a light conducting layer;
a light injection assembly (20) comprising:
a light coupling element (28), having a cavity (36); and
a lighting means (22) having an emitting face (25), positioned inside said cavity (36) and connected to the light coupling element (28), and/or to the at least one glass layer (202);
wherein the light coupling element (28) is geometrically shaped and configured to provide optimal light injection angles into the at least one glass layer (202);
wherein the light coupling element (28) is configured to allow Total Internal Reflection (TIR) within said light coupling element (28) to at least a portion of the light emitted by the lighting means (22); and
wherein the light coupling element (28) is attached to a major surface of the at least one glass layer (202).

Lighting means and light emitting means may be used interchangeably. It should be noted that other lighting means may be used in place of the LEDs (21) of the described embodiments of this disclosure without departing from the concept of the invention. Any means that can provide the intensity and meet the packaging requirements may be utilized including, incandescent, halogen, fiber optics, light pipes and even means not yet invented. Further, any combination may be used.

In another embodiment, the lighting means (22) may comprise a light source (26) located separate from the rest of the light injection assembly (20) and delivered by means of a waveguide to the emitting face of the lighting means located inside the cavity. We shall consider all of these as lighting emitting means regardless of the type of light source and method of delivery as equivalent. Therefore, in the context of this invention, even the inclusion of at least a portion of the lighting means in the cavity is considered as a total inclusion, e.g., when only the emitting face of the lighting means is located inside/on a surface of the cavity.

The type of light emitted by the lighting means (22) of the invention includes but is not limited to collimated, uncollimated, white, monochromatic, infrared, multi-wavelength light, RGB light or any combination depending upon the application.

The lighting means (22) may be connected to a printed circuit board (PCB) 32. The PCB (32) may be positioned outside the light coupling element (28) providing several advantages such as improvements in the heat management allowing for the lighting means avoid overheating, decreasing of the final size of the light coupling element, and facilitating interchangeability of parts within the light injection assembly.

Advantageously, the PCB (32) may be housed by the housing and/or encapsulation (30) such as to be protected against humidity and/or exterior agents, as depicted in FIG. 1G.

Additionally, a heat dissipation means may be connected to the lighting means and/or PCB. In a preferred embodiment, an additional encapsulation (30) houses the PCB (32) and the coupling element (28).

In another embodiment of the invention the glazing (200) further comprises a light collimator, wherein the emitting face (25) of the light source (26) located inside the cavity of the light coupling element (28) faces the light collimator.

With respect to light injection, the angle of injection as discussed is the theoretical angle that a perfect single ray traveling through a perfect optical path would make with respect to the major surface normal. In practice, all of the photons will not be at the exact angle desired, but a substantial portion will be at or within a tolerance at which the TIR will occur.

The angle of the injected light must be greater than the critical angle for TIR to occur. This critical angle is the smallest angle of incidence at which total internal reflection occurs. The critical angle is a function of the refractive index of the two media that the light passes through.

When using a light guide such as a light coupling element (28), the path of light from light emitting face (25) of the light source (26) to the surface normal at the injection point on the glass need not be aligned. In fact, any light source (26) orientation and alignment may be used as best suits the application. As an extreme example, the light emitting face (25) of the light source (26) can emit light 180 degrees from the injection point surface. The light source (26) also can be located further from the glass surface.

The light coupling element (28) may additionally comprise a lens (24) positioned in the path of the emitted light and facing the emitting face (25) of the light source (26). The light exiting from the light source (26) that is dispersed, such as by reflections onto the surface of the lens (24) or by the light rays that are injected at shallow angles onto the interface between the light coupling element (28) and the major surface (104) of the glass layer (202), is partially reflected back into the coupling element (28). Due to the geometrical shape of the light coupling element (28), a substantial portion of this internally dispersed light, such as 5-80%, preferably 10-80%, may be re-collected and redirected to the glazing by a series of succeeding reflections onto several regions of the perimetral surface of the light coupling element (28) such that it reaches again the glazing at an angle within the range that allows for light re-injection into the glazing.

An illustration of this event can be found in FIGS. 1B and 1C. This phenomenon surprisingly provides additional benefit, because it results into higher illumination efficiency, i.e., the light emitted by the light means is more efficiently used and less light is dispersed. This increase in efficiency provided by using the teachings of the invention may result in at least 3%, preferably 5% higher increase in light intensity onto the glazing.

Advantageously, the lens (24) may be positioned in such a way that optimizes the injection of one or more wavelength ranges of light rays coming from the lighting means (22). For instance, on a RGB LED (but not restricted to it) lighting means (22), the red and/or the blue and/or the green range/ranges of colored light rays may be guided in a more efficient way, i.e., minimizing light loss, by adjusting the position, angle of inclination and geometric shape of the lens (24).

In a particular embodiment, the lens (24) is incorporated into the lighting means (22).

Advantageously, the ratio between the maximum width and height of the light coupling element (28) may be preferably of at least 2.2, preferably at least 2.7, more preferably at least 3. Furthermore, a reflective coating (not shown in the figure) could be directly in contact with the external perimetral surface of the light coupling element (28) with the purpose of increasing light reflection inside the light coupling element. The coating could also be applied to a portion of the external perimetral surface of the light coupling element as mentioned previously. Tests have been shown that the addition of a reflective coating may result in an incremental increase of 2 to 5% of the light illumination intensity.

The automotive glazing can be provided with light boosting means (7) facing the coupling element (28). In an embodiment, when the glazing is a laminated glazing, the light boosting means (7) can be arranged in any position between the number three major surface (103) and number two major surface (102) and preferably between the number three surface (103) and the bonding plastic layer (4). The light boosting means (7) are any means able to reflect and/or redirect the light injected from the light coupling element (28) into the conducting layer (202). The light injected that could not initiate the TIR inside the light conducting layer (202) can be reflected back and redirected into the light coupling element (28) and coupled again with higher efficiency. Additionally, or alternatively, the geometry of the lighting boosting means (7) can modify the angles of incidence of the injected light to increase the amount of refracted light able to perform TIR within the light conducting layer (202). The reflective means can be formed but not limited to, as a reflective coating, a reflective film, a film with a reflective coating, an insert, a deflective structure with a regular o irregular rugosity, or any combination thereof or any means able to reflect and/or redirect the injected light. In order to optimize the lamination of the laminated glazing, the light boosting means (7) has preferably a maximum thickness of ⅓ than the total thickness of the layers disposed between number two major surface and number three major surface.

The light coupling element (28) may also comprise protection means against humidity and/or external agents by having a housing and/or being encapsulated (30) The housing material can have an index of refraction (IOR), n₁, that is less than that of the light coupling element, n₂.

This is accomplished by using a material with the desired IOR for the housing. Alternatively, a material with the appropriate IOR can be applied between the light coupling element and the housing interior interface. We shall refer to this material as cladding. For an optimal light coupling, the materials are carefully selected for the light coupling element (28) and the housing (30) such that each has an index of refraction respecting the following condition wherein n1<n2≥n3.

The light coupling element (28) has an index of refraction n2, and the at least one glass layer (202) has an index of refraction n3, such that the absolute value of the difference between n2 and n3 is at most 0.15, preferably at most 0.1 and more preferably at most 0.05. In one embodiment, the cavity (36) is filled with the same material of the light coupling element (28), or another additional coupling agent having an index of refraction within ±0.15 of n2. In a preferred embodiment, the present invention provides an illuminated automotive glazing, comprising at least one glass layer (202), having an index of refraction n3, major surfaces, and serving as a light conducting layer; a light coupling element (28) being geometrically shaped, having an index of refraction n2, having a cavity (36); and a lighting means (22) having an emitting face (25), positioned inside said cavity (36) and connected such as attached, fixed or making physical contact to the light coupling element (28), and/or to the at least one glass layer (202), wherein said light coupling element (28) is configured to provide optimal light injection angles into the surface of the at least one glass layer (202) and is also configured to allow Total Internal Reflection (TIR) within said light coupling element (28) to at least a portion of the light emitted by the lighting means (22), and wherein the light coupling element (28) is attached to a major surface (104) of the at least one glass layer (202).

In a laminated glazing having at least two glass layers, such as an outer glass layer (201) and an inner glass layer (202), the light coupling element (28) is disposed on surface four, (104), of the inner glass layer (202). Therefore, the lamination with the plastic bonding layer (4) is performed by the opposite side of the light coupling element (28) position. The light coupling element (28) may be fabricated of a transparent plastic or of any of the material mentioned above. The light coupling element (28) may either be coated with or embedded in a second material with a lower index of refraction than the material that the light guide is made from or be surrounded by a media with a lower index of refraction. This second material with lower index of refraction may serve as a housing (30) and/or may be considered a cladding. For common transparent plastics, total internal reflection will occur with the light coupling element (28) surrounded by air as well as a number of liquids.

For some applications, rather than using a transparent media to surround or coat the light coupling element (28), it may be partially or substantially coated with a reflector means (23) which corresponds to a highly reflective material such as a reflective coating, or other type of reflector.

One option for installing the light assembly onto the glazing is by bonding the light coupling element directly onto the glazing. This can be done by means of direct application of the coupling element material onto the glass major surface (104). Methods of direct applications include, but are not limited to injection, pouring, and casting.

Alternatively, the light coupling element (28) may be attached to the major surface (104) of the glass layer (202) by means of an adhesive (40) having an index of refraction n₄. For the optimum light coupling, the condition for the selection of the adhesive (40) is that it is transparent and has an index of refraction: a) matching either the index of refraction of the light coupling element (28) n₂ or the one of the glass layer (202) n₃ within a range of a maximum difference in absolute value of 0.05; or b) in between, i.e., n₂≥n₄≥n₃.

Adhesive (40) refers to any polymeric material capable of keeping the light coupling element (28) in its position and is used to bond the coupling element (28) to the glass major surface.

The adhesive (40), as applied in its fluid state and after processing, it generates the needed coupling between the light coupling element (28) and the glass major surface (104).

Advantageously, the use of this type of adhesive enables to couple light coupling elements (28) having different curvatures to glass surfaces having also different curvatures.

This adhesive may be selected from different liquid adhesives such as liquid optical clear adhesives (LOCA). In an embodiment, the LOCA adhesive (40) is selected from the group comprising UV curable resin, polymer, silicone, acrylic, urethane, sulfide based and combinations thereof. The adhesive (40) is polymerized by the action of a catalyst that may be activated by different means, such as moisture, UV radiation, IR thermal radiation, temperature, plasticizer, or by reaction with another chemical component. After processing, i.e., polymerization or curing, the adhesive (40) provides the needed features to generate an optimal coupling between the light coupling element (28) and the glass surface (104).

In a preferred embodiment, the adhesive (40) has a refractive index n₄ within a range of 1.35 and 1.75, more preferably between 1.48 and 1.53 and/or a visible light transmittance in the range of 90 to 100%. Likewise, in a preferred embodiment, the adhesive (40) having those refractive index ranges is a cured adhesive.

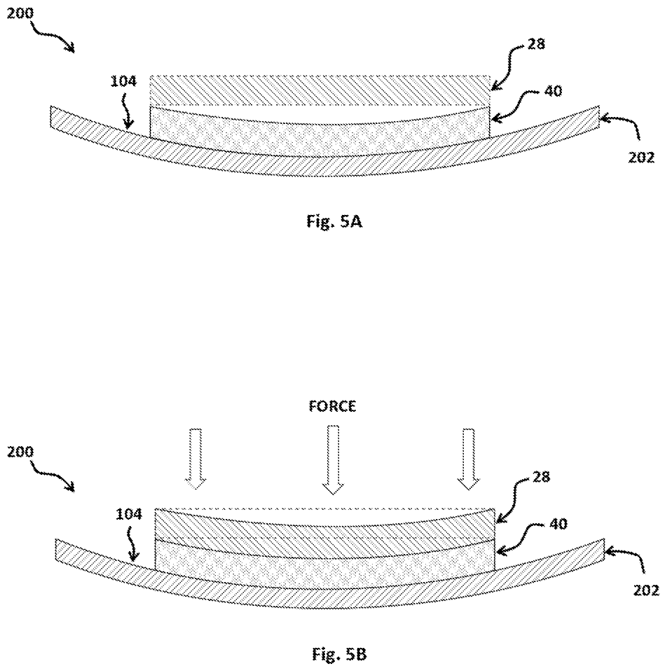

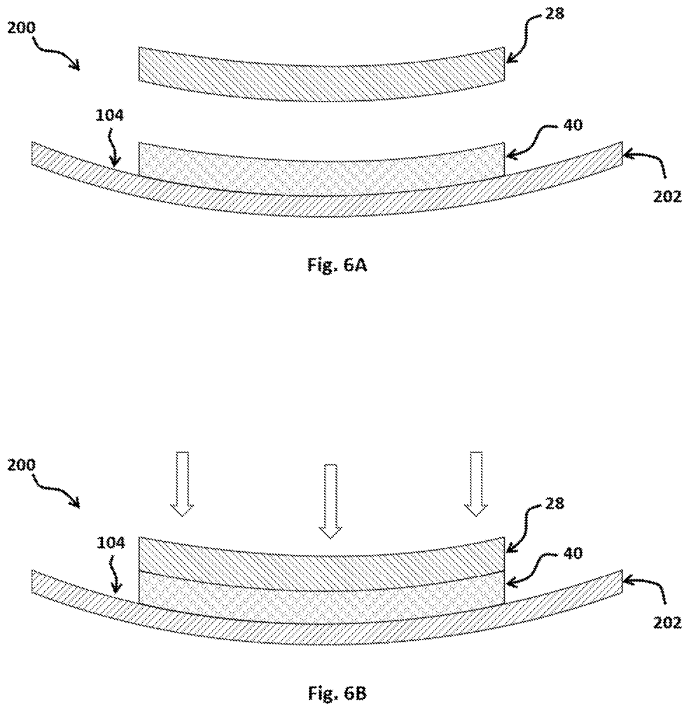

Different means for coupling adhesive (40) to the major surface of the glass layer (202) are shown in FIGS. 4, 5 and 6. In the embodiment depicted in FIGS. 4A, a cross section of the coupling element (28), and 4B, a longitudinal section of the coupling element (28), the light coupling element (28) is first placed in the desired position on a portion of the curved glass major surface (104), forming a void or empty space with a non constant thickness that is filled with adhesive (40) in its fluid state, then the processing step occurs, and the coupling is performed. FIGS. 5A and 5B, longitudinal sections of the coupling element (28), are similar to the previous embodiment, but first the adhesive (40) is applied to the portion of curved glass major surface (104), to the light coupling element (28) and/or both, and then a force is applied to the light coupling element (28) to place it in position, so as to generate in the longitudinal section of the light coupling element (28) substantially same curvature of the portion of the major surface (104) of the glass layer (202) where it is disposed. In this embodiment the light coupling element (28) is a flexible light coupling element and can have its longitudinal section straight or precurved. FIGS. 6A and 6B, longitudinal sections of the coupling element (28), are like the previous embodiments, but first the adhesive (40) is applied to the portion of curved glass major surface (104), to the light coupling element (28) and/or both, and then a light coupling element (28) is placed in the desired position. The light coupling element (28) has a longitudinal section with a curvature that is substantially the same than the curvature of the portion of the major surface (104) of the glass layer (202) where it is disposed. In this last embodiment, the light coupling element (28) is a rigid light coupling element and the advantage is that the stress in the union area is minimized or does not exist.

A fourth aspect of the invention, not claimed, is provided by an illuminated glazing comprising a coupling element bar type that is attached to a portion of a major surface of a curved glass layer by an adhesive, wherein the curvature of the light coupling element in its longitudinal section is substantially the same than the curvature of the portion of the major surface glass layer (202) where the light coupling element is disposed, and wherein the coupling element can be rigid or flexible. All embodiments disclosed in this invention are applicable to this fourth aspect of the invention. Likewise, this fourth aspect of the invention is not restricted to the light injection assembly (20) disclosed in claim 1.

In the context of this invention, it is considered that the curvature of the light coupling element (28) and the portion of glass major surface (104) where it is disposed are substantially the same, when the maximal gap between the light coupling element (28) and the portion of glass major surface (104) where it is disposed is not more than 5 mm, preferably no more than 2 mm and more preferably no more than 1 mm.

Additional components could be integrated into the glazing. For instance, solar control coatings, films and performance plastic bonding layers could be applied to a glass surface of the glazing or be integrated into the glazing stack. Variable light transmission films, such as liquid crystal (LC), Polymer Dispersed Liquid Crystal (PDLC), Suspended Particle Device (SPD), and other functional films such as head up display films (HUD), holographic films (HoE) may also be integrated into the glazing and may function in combination with the illumination system proposed by the invention. The variable light transmissions films can be a colored switchable film, more preferably a black-PDLC. Tinted switchable films can provide the needed darkening, in either possible state.

When variable light transmission films are included, multiple plastic bonding layers (4) may be used within the glazing. The plastic bonding layer may be clear, colored or any combination thereof. The clear plastic bonding layer has a total visible light transmission of at least 80%, preferably from 80 to 90% and more preferably of at least 86%. A dark plastic bonding layer has a total visible light transmission that ranges from 0 to 18%, more preferably from 0 to 13% measured according to ISO 9050 (2003). In a preferred embodiment the glazing includes at least two clear plastic bonding layers. In another preferred embodiment, the glazing includes at least one clear plastic bonding layer and at least one colored plastic bonding layer. In yet another preferred embodiment, the glazing includes at least one clear plastic bonding layer and at least one dark plastic bonding layer.

While the focus of the embodiments and discussion of this invention is laminated automotive glazing such as windshields or roofs, it can be appreciated that the invention is not limited to laminated automotive windshields and roofs. The invention may be implemented with monolithic glazing as well as laminated glazing in any glazing positions in the vehicle. In the same manner, the invention may be implemented in any type of glazing including glazing that is not used in a vehicle such as in commercial, military, marine, rail, aerospace, and other vehicles as well as in stationary applications such as building windows, doors, and partitions. Furthermore, the invention may be used to inject light into any transparent material with parallel surfaces.

According to a second inventive aspect of the invention, an automotive roof is provided, which comprises the illuminated automotive glazing of the first inventive aspect.

The automotive glazing (200) can comprise a disposition of a plurality of light injection assemblies (20) electrically interconnected, preferably in line interconnected. The light injection assemblies (20) are preferably arranged in the longitudinal direction of the light coupling element (28). This disposition facilitates the adjustment to a curved geometry on a glazing and allows an easy exchange of a single light injection assembly (20) of the disposition if a failure in a particular light injection assembly (20) occurs.

In the context of this invention, the disposition of a plurality of light injection assembly (20) electrically interconnected is defined as light module (50). The light injection assemblies (20) of the light module (50) can be interconnected in a way that each of them can be electronically controlled independently. The number of light injection assemblies (20) within the light module (50) and the number of light modules (50) disposed on an illuminated automotive glazing can vary, depending on the geometry and illumination requirements of the glazing.

In an embodiment, a light module (50) can preferably have from 2 to 20 light injection assemblies (20) electrically interconnected. Likewise, the automotive glazing can have from 2 to 10 light modules (50).

In the context of this invention, a driver (70) is the electronic assembly that performs the electronic control of the light source (26). The driver (70) is an electrical circuit used to power a light source (26) and control performance like brightness, color, intensity among others, but it limits also the current to prevent damaging on it. Particularly, the driver (70) may control any light source (26) provided by the lighting means (22). The driver (70) is considered as part of the light injection assembly (20) and may be integrated within the light source (26) or in a different disposition. In a preferred embodiment the driver (70) is a LED driver.

In one embodiment, when the driver (70) is integrated with the light source (26), the light source (26) comprises a plurality of smart LEDs, disposed inside the cavity (36). A smart LED (27) should be understood in the context of this invention as a LED having an integrated driver (70).

In another embodiment, the driver (70) is arranged on the same substrate (34) where the light source (26) of the lighting means (22) is disposed inside the cavity (36). In a particular case of this embodiment, the light source (26) comprises a plurality of LEDs (21) disposed on an FPC or a PCB inside the cavity (36).

In yet another embodiment, the driver (70) is disposed outside of the light coupling element (28) of the light injection assembly (20). Advantageously, this disposition improves the thermal performance of the light injection assembly (20). The coupling element (28) comprises a slot (29) that enables to provide the electrical connections (35) for connecting the lighting means (22) disposed inside of the coupling element (28), with the driver (70) disposed outside of the coupling element (28) on a second or additional substrate (32). In a particular embodiment, the slot (29) preferably has a width from 3 mm to 40 mm. In a particular case of this embodiment, the second substrate is a PCB or an FPC disposed outside of the coupling element (28).

The light injection assembly (20) disposed on an automotive glazing can be controlled by one or multiple Electronic Control Units (73) (ECU). In the context of this invention, and for the purpose of defining electronic interaction, the device acting as electronic controller initiating the commands is known as master (71). The device that responds accordingly is known as slave (72).

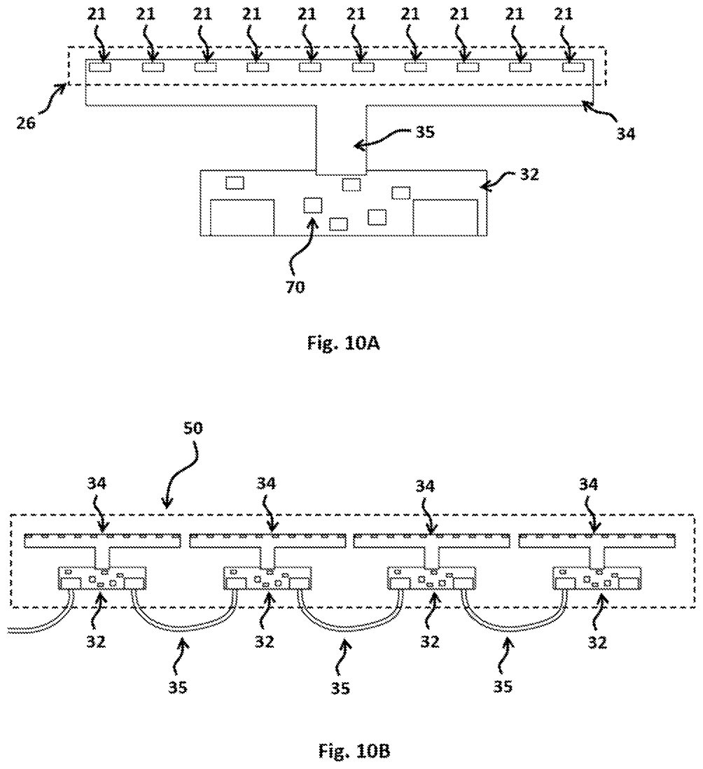

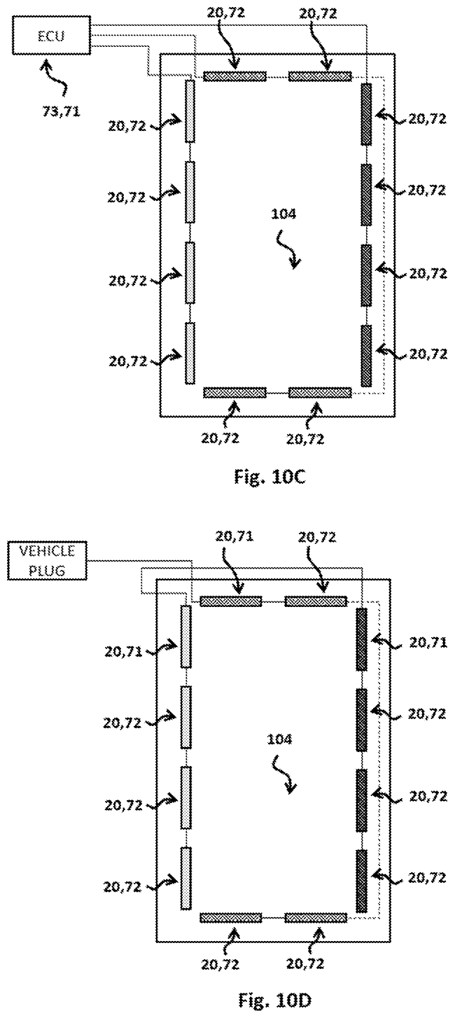

In one embodiment, at least an external ECU (73) acts as a master (71) controlling the drivers (70) of the light injection assembly (20) that are acting as slaves (72). This embodiment is shown in FIG. 10C.

In another embodiment, at least one driver (70) of the light injection assembly (20) of the light module (50) is acting as master (71) and the other drivers (70) of the light module (50) are slaves (72) and there is not external electronic control by an ECU. This embodiment is shown in FIG. 10D.

In another embodiment, at least an external ECU (73) acts as a master (71) controlling the drivers (70) and at least one driver (70) of the light injection assembly of the light module (50) acts as master (71).

### DESCRIPTION OF PREFERRED EMBODIMENTS OF THE INVENTION

The invention is related to a light injection assembly attached to an automotive glazing. All embodiments disclosed are based upon large glass layers such as a panoramic roof of one or multiple glass layers such as a monolithic or laminated glazing. The overall dimensions of the glazing are 1200 mm by 800 mm. It is important to note that the invention may also work with any glazing dimension. In one embodiment of the invention the glazing is a laminated glazing comprised of an outer glass layer (201) clear soda lime glass having a thickness of 3.2 mm. It should be noted that any glass composition may be used without departing from the spirit of the invention. The inner glass layer (202) is comprised of 2.2 mm thick ultra-clear soda-lime glass. Here again, any composition would work. A PVB plastic bonding layer (4) is used to laminate the two glass layers together. A black frit obscuration (6) may be printed on any surfaces. Most commonly a black frit obscuration (6) may be printed onto surfaces two, (102), and/or four, (104). The glass layers may be press bent to shape or gravity bent. The bent glass layers are laminated.

Conventionally, the inner glass layer (202) is the light conducting layer. However, the outer glass layer (201) as well as any plastic bonding layer could also serve as a light conducting layer without departing from the spirit of the invention.

In the preferred embodiments the light scattering means (60) are disposed onto surface three, (103), of the inner glass layer, as illustrated in FIG. 1A.

One embodiment of this invention is illustrated in FIG. 1A. In this embodiment, the light injection assembly (20) is comprised of a light coupling element (28), a lighting means (22) and a lens (24). The lighting means (22) is positioned in the interior of the light coupling element (28), inside a cavity (36), and away from the perimetral surface of the coupling element (28).

The lighting means emitting face (25) is positioned to emit light at an angle in the range between 0 to 90, preferably 20 to 80 degrees with respect to the glazing surface normal.

The lens (24) is positioned in the path of the emitted light. The lens (24) is used for concentrating and/or guiding the light at the range of angles optimized for injection into the glazing. The lens (24) concentrates the light exiting from the lighting means (22) into the glazing.

In one embodiment, the light coupling element (28) has an index of refraction between 1.48 and 1.6, more preferably 1.51 and 1.59.

In another embodiment of the invention, the light coupling element (28) is comprised of multiple pieces such as two pieces (281) and (282) illustrated in FIG. 1E.

In another embodiment of the invention, the light coupling element (28) is comprised of three pieces (281), (282) and (283) such as illustrated in FIGS. 1F and 1G.

In another embodiment of the invention, the light coupling element (28) is comprised of more than one cavity (36) such as two cavities as illustrated in FIGS. 1F and 1G.

In another embodiment of the invention, the light coupling element (28) is comprised of more than one lens (24), such as two or three lenses as illustrated in FIG. 1G.

In another embodiment of the invention, the light coupling element (28) may comprise a housing (30) surrounding it for protection against humidity and/or external agents such as illustrated in FIG. 1G. Alternatively or in combination with the housing, an encapsulation could be disposed around the light coupling element (28).

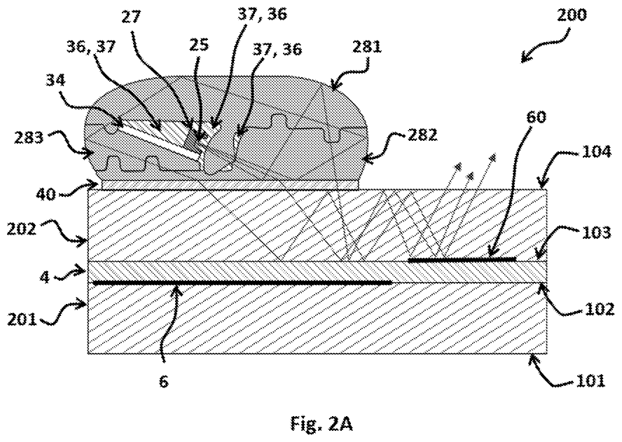

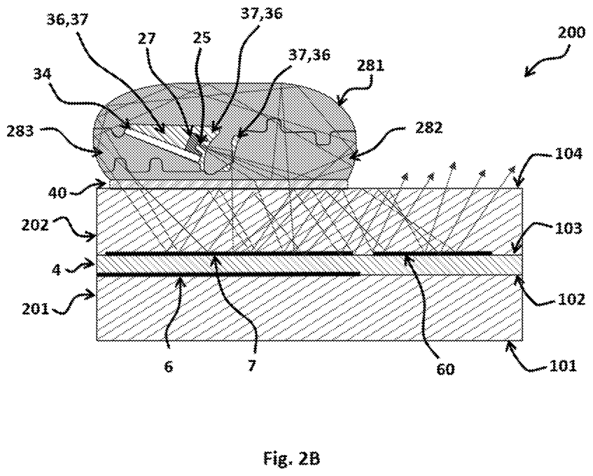

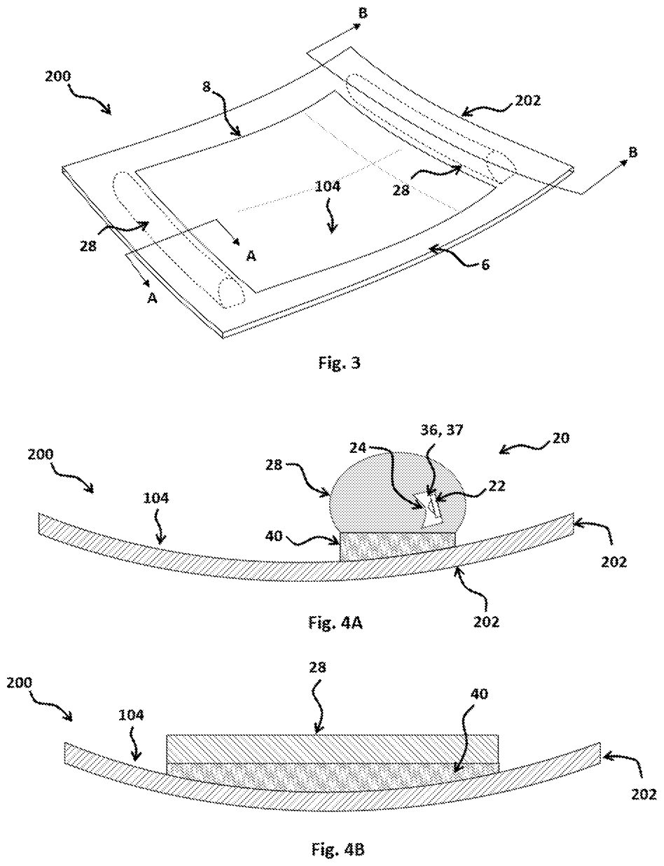

In another embodiment of the invention, illustrated in FIG. 2A, the lighting means (22) located in the in cavity (36) are surrounded by an air gap (37). In this embodiment the light coupling element (28) comprises multiple cavities (36) and the cavities are an air gap (37). In this embodiment the light source (26) is a Smart LED (27).

In another embodiment of the invention, illustrated in FIG. 2B, the illuminated automotive glazing (200) comprises boosting means (7) facing the coupling element (28) and arranged on the glass major surface (103). In this embodiment the light source (26) is a Smart LED (27).

In another embodiment of the invention, the light coupling element (28) is attached, bonded, fixed and/or maintained in its position by an adhesive (40) as depicted in FIGS. 4A, 4B, 5A, 5B, 6A and 6B.

In the embodiment depicted in FIGS. 4A, a cross section of the coupling element (28), and 4B, a longitudinal section of the coupling element (28), the light coupling element (28) is first placed in the desired position on the curved glass surface (104), forming a void or empty space with a non-constant thickness filled with the adhesive (40).

The embodiment depicted in FIGS. 5A and 5B corresponds to a flexible light coupling element (28) and how to arrange it on the glass layer major surface. First, the adhesive (40) is applied to the curved glass major surface, to the light coupling element (28) and/or both, and then a force is applied to the light coupling element (28) to place it in position, so as to generate in the light coupling element (28) substantially the same curvature than that of the portion of the major surface (104) of the glass layer (202) where it is disposed.

The embodiment depicted in FIGS. 6A and 6B, corresponds to a rigid curved light coupling element (28) and how to arrange it on the glass surface. First, the adhesive (40) is applied to the curved glass major surface, to the light coupling element (28) and/or both, and then the curved light coupling element (28) is placed in the desired position. The curvature of the light coupling element (28) is substantially the same than the curvature of the portion of the major surface (104) of the glass layer (202) where the light coupling element (28) is disposed.

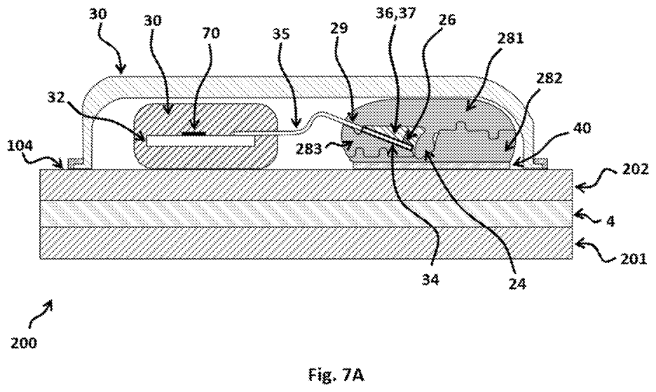

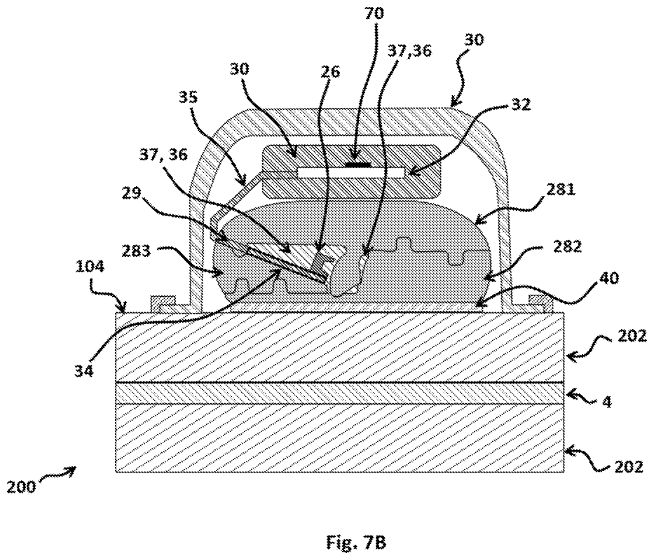

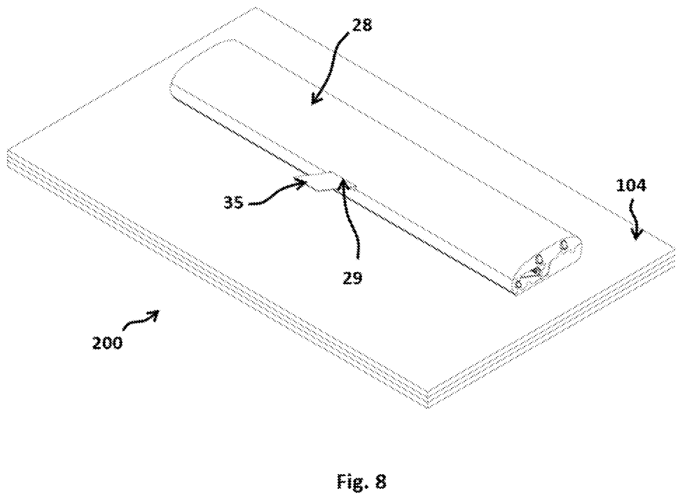

In another embodiment of the invention, the coupling element (28) comprises a slot (29) that enables to provide the electrical connections (35) connecting the lighting means (22) disposed inside of the coupling element (28) with the driver (70) disposed outside of the coupling element (28) on a PCB (32) which is disposed on the surface of the glass major surface (104). This embodiment is illustrated in FIG. 7A. In this embodiment, the PCB is protected with a housing (30) and the Light injection assembly (20) is also protected with a housing (30).

The embodiment depicted in FIG. 7B is similar to the one of 7A but the PCB (32) is disposed over the light coupling element (28), so the width of the light injection assembly (20) is reduced in comparison with the previous embodiment.

In another embodiment, the light coupling element (28) is attached to an along the major surface (104) of the glazing (200) and it is disposed facing the obscuration (6) and arranged close to the inner edge of the obscuration (8), as depicted in FIGS. 9A, 9B and 9C. FIG. 9A shows four light coupling elements (28) located in four sides of the glazing. FIG. 9B shows two light coupling elements (28) located in two sides (lateral edges) of the glazing and FIG. 9C shows one light coupling elements (28) located in one side (frontal edge) of the glazing.

In one embodiment depicted in FIG. 10A, the light source (26) is an array of LEDs (21) and is sometimes called a light bar or light strip. The LEDs are arranged on a FPC (34). The light strip is electrically connected (35) to an PCB (32) where the driver (70) is arranged.

FIG. 10B shows an embodiment with a plurality of light injection assemblies (20) electrically in line interconnected and where the light injection assemblies (20) are arranged in the longitudinal direction of the light coupling element (28).

FIG. 10C shows an embodiment of illuminated automotive glazing (200) with three light modules (50) arranged along the four sides of the major surface (104) of the glazing, where an external ECU (73) acts as a master (71) and drivers (70) of the light injection assemblies (20) are acting as slaves (72).

FIG. 10D shows an embodiment of illuminated automotive glazing (200) with three light modules (50) arranged along the four sides of the major surface 104 of the glazing where one driver (70) of the light injection assembly (20) of the light module (50) is acting as master (71) and the other drivers (70) of the light module (50) are slaves (72) and there is not external electronic control by an ECU.

1. An illuminated automotive glazing (200), comprising:
at least one glass layer (202), having a major surface three (103), and a major surface four (104), and serving as a light conducting layer;
a light injection assembly (20) comprising:
a light coupling element (28), having a cavity (36); and
a lighting means (22) having an emitting face (25), positioned inside said cavity (36) and connected to the light coupling element (28), and/or to the at least one glass layer (202);
wherein the light coupling element (28) is geometrically shaped and configured to provide optimal light injection angles into the at least one glass layer (202);
wherein the light coupling element (28) is configured to allow Total Internal Reflection (TIR) within said light coupling element (28) to at least a portion of the light emitted by the lighting means (22); and
wherein the light coupling element (28) is attached to a major surface of the at least one glass layer (202).

2. The illuminated automotive glazing (200) of the preceding claim, wherein the light coupling element (28) has a core having an external perimetral surface shape portion selected from the group comprising of elliptical-like, oval-like, convex shape, cylindrical, toroidal/spherical, parabolic, conical shape, or a polyhedron having number of sides and side lengths approximating an elliptical or oval shape, or the combination thereof.

3. The illuminated automotive glazing (200) of any of the preceding claims, wherein the lighting means emitting face (25) is positioned to emit light at an angle in the range between 0 to 90, preferably 20 to 80 degrees with respect to the glazing surface normal.

4. The illuminated automotive glazing (200) of any of the preceding claims, wherein the light coupling element (28) has an index of refraction n₂, and the at least one glass layer (202) has an index of refraction n₃, such that the absolute value of the difference between n₂ and n₃ is at most 0.15.

5. The illuminated automotive glazing (200) of any of the preceding claims, wherein the ratio between the maximum width and height of the light coupling element (28) is of least 2.2, preferably at least 2.7, more preferably at least 3.

6. The illuminated automotive glazing (200) of any of the preceding claims, wherein the lighting means (22) is inserted into the cavity (36) such that an air gap (36) separates the emitting face (25) of the lighting means (22) from the light coupling element (28).

7. The illuminated automotive glazing (200) of any of the preceding claims, further comprising at least one lens (24) positioned in the path of the emitted light and facing the emitting face (25) of lighting means (22).

8. The illuminated automotive glazing (200) of claim 7, wherein at least one of said at least one lens (24) is formed by the interface surface between the air gap (36) and the light coupling element (28).

9. The illuminated automotive glazing (200) of any of the preceding claims, wherein the light coupling element (28) is made of a material selected from the group comprising engineering plastics, transparent polyurethane (PU), polycarbonate (PC), polymethyl methacrylate (PMMA), LSR, silicone, polyamide (PA), thermoplastic polyurethane (TPU), cyclic olefin Polymer (COP), cyclic olefin copolymer (COC), quartz, glass transparent alumina or the combination thereof.

10. The illuminated automotive glazing (200) of any of the preceding claims, wherein the light coupling element (28) is attached to the major surface (104) of glass layer (202) by means of an adhesive (40).

11. The illuminated automotive glazing (200) of claim 15, wherein the adhesive (40) is transparent and has an index of refraction n₄: a) matching either the index of refraction n2 of the light coupling element (28) or the index of refraction n3 of the glass layer (202) within a range of a maximum difference of 0.05 in absolute value; or b) in between n2 and n3, such that n2≥n4≥n3.

12. The illuminated automotive glazing (200) of claim 10, wherein the adhesive (40) has a refractive index n4 ranging from 1.35 to 1.75 and/or a visible light transmittance in the range of 90 to 100%.

13. The illuminated automotive glazing (200) of any of the preceding claims, wherein the light coupling element (28) material is made from a rigid material or a flexible material.

14. The illuminated automotive glazing (200) of claim 13, wherein the curvature of the longitudinal section of the light coupling element (28) is substantially the same than the curvature of the portion of the major surface (104) of the at least one glass layer (202) where the light coupling element (28) is disposed.

15. The illuminated automotive glazing (200) of the preceding claims, wherein the hardness of the light coupling element (28) material is no more than 100 Shore A, preferably within 50 to 100 Shore A and/or 50 to 100 Shore D.

16. The illuminated automotive glazing (200) of any of the preceding claims, wherein the light coupling element (28) is directly attached to the major surface (104) of the at least one glass layer (202).

17. The illuminated automotive glazing (200) of any of the preceding claims, wherein the light coupling element (28) is either partially or fully covered by reflector means (23), and preferably by a reflective coating.

18. The illuminated automotive glazing (200) of any of the preceding claims, wherein the light coupling element (28) further comprises a housing and/or is encapsulated (30).

19. The illuminated automotive glazing (200) of any of the preceding claims, further comprising at least one printed circuit board (32) connected to the lighting means (22).

20. The illuminated automotive glazing (200) of any of the preceding claims, wherein the lighting means (22) is comprised of LEDs (21).

21. The illuminated automotive glazing (200) of any of claim 20, wherein the LEDs (21) are Smart LEDs (27).

22. The illuminated automotive glazing (200) of any of the preceding claims, further comprising at least one additional glass layer (201), wherein said at least one glass layer (202) and the at least one additional glass layer (201) are laminated with at least one plastic bonding layer (4); wherein the major surface three (103) of the at least one glass layer (202) is facing the at least one plastic bonding layer (4); and wherein the light coupling element (28) is attached to the major surface four (104) of the at least one glass layer (202).

23. The illuminated automotive glazing (200) of claim 22, further comprising a light boosting means (7) facing the coupling element (28), and arranged between the glass major surfaces (102, 103) of the at least one additional glass layer (201) and the at least one glass layer (202).

24. The illuminated automotive glazing (200) of any of the preceding claims, wherein the glazing comprises at least one light coupling element (28) and at least one of said light coupling element (28) is attached to and along the surface of the at least one glass layer (202) close to one or more edges of the glazing.

25. The illuminated automotive glazing (200) of any of the preceding claims, wherein the coupling element (28) is disposed facing the obscuration (6) and where the distance between the coupling element (28) and the inner edge of the obscuration (8) is preferably less than 400 mm, more preferably less than 200 mm and even more preferably less than 80 mm.

26. The illuminated automotive glazing (200) of any of the preceding claims, wherein the glazing comprises a disposition of a plurality of light injection assemblies (20) electrically in line interconnected.

27. A vehicle roof comprising an illuminated automotive glazing (200) of any of the preceding claims.
